(19) United States
(12) Patent Application Publication
(10) Pub. No.: US 2015/0099112 A1
(43) Pub. Date: Apr. 9, 2015

(54) RESIN FOAM AND FOAM SEALING MATERIAL

(71) Applicant: NITTO DENKO CORPORATION, Ibaraki-shi, Osaka (JP)

(72) Inventors: Makoto Saitou, Ibaraki-shi (JP); Kazumichi Kato, Ibaraki-shi (JP); Kiyoaki Kodama, Ibaraki-shi (JP); Naohiro Kato, Ibaraki-shi (JP)

(73) Assignee: NITTO DENKO CORPORATION, Ibaraki-shi, Osaka (JP)

(21) Appl. No.: 14/382,170

(22) PCT Filed: Dec. 18, 2013
(86) PCT No.: PCT/JP2013/083875

§ 371 Date: Aug. 29, 2014

(30) Foreign Application Priority Data
Dec. 21, 2012 (JP) 2012-279546
Dec. 21, 2012 (JP) 2012-279547
Dec. 21, 2012 (JP) 2012-279548
Dec. 21, 2012 (JP) 2012-279549
Dec. 21, 2012 (JP) 2012-279550
Dec. 21, 2012 (JP) 2012-279551

(51) Int. Cl. C09J 7/02; C09J 167/03; C08J 9/12

(52) U.S. Cl. CPC C09J 7/0289; C08J 9/122; C09J 167/03; C09J 2453/00; C08J 2367/03; C09J 2433/00
USPC 428/354; 521/182; 428/343; 428/355 AC

(57) ABSTRACT

There is provided a resin foam excellent in deformation recovery performance after compressive deformation. The resin foam of the present invention has a stress retention to be defined below of not less than 70%: stress retention (%)=(compressive stress after 60 seconds)/(compressive stress after 0 seconds)×100 wherein a resin foam in a sheet form having a thickness of 1.0 mm is compressed in the thickness direction so that the resin foam has a thickness of 20% of the initial thickness, and the compression state is held; and the compressive stress immediately after compression is defined as “compressive stress after 0 seconds,” and the compressive stress 60 seconds after holding the compression state is defined as “compressive stress after 60 seconds.”

### TECHNICAL FIELD

The present invention relates to a resin form and a foam sealing material containing the resin foam. For example, it relates to a polyester resin foam and a foam sealing material containing the polyester resin foam.

### BACKGROUND ART

Conventionally, a resin foam has been used in electric or electronic appliances for the purpose of dustproofing, shading, and shock absorption. For example, the resin foam is used as a sealing material around a display such as a liquid crystal display (LCD) of portable electric or electronic appliances such as cellular phones and personal digital assistants.

Known examples of such resin foams include a polyurethane resin foam having a micro-cell structure with a high-density open-cell structure, a resin foam obtained by compression molding of a highly-expanded polyurethane resin foam, a polyethylene resin foam having a closed-cell structure and an expansion ratio of about 30 times, a polyolefin resin foam having a density of not more than 0.2 g/cm³, and a polyester resin foam (refer to Patent Literatures 1 and 2).

### CITATION LIST

### Patent Literature

Patent Literature 1: Japanese Patent Laid-Open No. 2005-227392
Patent Literature 2: Japanese Patent Laid-Open No. 2007-291337

### SUMMARY OF INVENTION

### Technical Problem

In recent years, upsizing and high definition of a screen of a display have advanced in portable electric or electronic appliances. Under such circumstances, a problem is becoming apparent that a force is applied to the screen by the repulsion of a resin foam used as a sealing material, causing color unevenness on the screen.

In order to prevent such a problem from occurring, the resin foam used as a sealing material may be used in the state where it is not compressed too much.

However, a gap occurring due to deformation of portable electric or electronic appliances may reduce functions such as dustproofing, shading, cushioning, and shock absorption of the resin foam used as a sealing material. As a means to cope with such deformation, a pressure-sensitive adhesive layer may be provided on the resin foam. The processing for forming a pressure-sensitive adhesive layer on the resin foam is performed by transferring a pressure-sensitive adhesive layer on the resin foam. However, the processing may cause a problem that since the resin foam is compressed with a rubber roller or the like through the pressure-sensitive adhesive layer when the pressure-sensitive adhesive layer is transferred, the cell structure of the resin foam may be crushed by the pressure to cause semipermanent deformation in the resin foam so that when the compression state is released, the thickness of the resin foam may not be recovered to that before the compression state.

Accordingly, an object of the present invention is to provide a resin foam, particularly a polyester resin foam, which is excellent in deformation recovery performance after compressive deformation.

Further, another object of the present invention is to provide a foam sealing material excellent in deformation recovery performance after compressive deformation.

### Solution to Problem

Thus, as a result of intensive studies, the present inventors have found that, in a resin foam, when stress retention to be defined below is not less than a predetermined value, deformation recovery performance after compressive deformation can be improved. The present invention has been made based on this finding.

Specifically, the present invention provides a resin foam having a stress retention to be defined below of not less than 70%, wherein

Stress retention (%)=(compressive stress after 60 seconds)/(compressive stress after 0 seconds)×100

wherein the compressive stress after 0 seconds and the compressive stress after 60 seconds are obtained as follows: a resin foam in a sheet form having a thickness of 1.0 mm is compressed in the thickness direction so that the resin foam has a thickness of 20% of the initial thickness in an atmosphere of 23° C., and the compression state is held; and the compressive stress immediately after compression is defined as “compressive stress after 0 seconds,” and the compressive stress 60 seconds after holding the compression state is defined as “compressive stress after 60 seconds.”

The resin foam preferably has an average cell diameter of 10 to 150 μm.

The resin foam preferably has a maximum cell diameter of less than 200 μm.

The resin foam preferably has an apparent density of 0.01 to 0.15 g/cm³.

The resin foam preferably has a repulsive force at 50% compression to be defined below of 0.1 to 4.0 N/cm²,

wherein the repulsive force at 50% compression is defined as a repulsive load when a resin foam in a sheet form is compressed in the thickness direction so that the resin foam has a thickness of 50% of the initial thickness in an atmosphere of 23° C.

The resin foam is preferably formed by allowing a resin composition containing a resin to expand.

The resin is preferably a polyester resin.

The resin foam is preferably formed through the steps of impregnating the resin composition with a high-pressure gas and subjecting the impregnated resin composition to decompression.

The gas is preferably an inert gas. The inert gas is preferably carbon dioxide gas. Further, the gas is preferably in a supercritical state.

In addition, the present invention provides a foam sealing material comprising the resin foam.

The foam sealing material preferably has a pressure-sensitive adhesive layer on the resin foam.

The pressure-sensitive adhesive layer is preferably formed on the resin foam through a film layer. Further, the pressure-sensitive adhesive layer is preferably an acrylic pressure-sensitive adhesive layer.

### Advantageous Effects of Invention

The resin foam of the present invention is excellent in deformation recovery performance after compressive deformation.

### DESCRIPTION OF EMBODIMENTS

### Resin Foam

The resin foam of the present invention has a stress retention to be defined below of not less than 70%.

Stress retention (%)=(compressive stress after 60 seconds)/(compressive stress after 0 seconds)×100

The compressive stress after 0 seconds and the compressive stress after 60 seconds: A resin foam in a sheet form having a thickness of 1.0 mm is compressed in the thickness direction so that the resin foam has a thickness of 20% of the initial thickness in an atmosphere of 23° C., and the compression state is held. The compressive stress immediately after compression is defined as “compressive stress after 0 seconds,” and the compressive stress 60 seconds after holding the compression state is defined as “compressive stress after 60 seconds.”

In the present specification, the stress retention defined above may be simply referred to as “stress retention.” Further, when a load is applied to a resin foam to thereby cause deformation, stress retention is an index of the action of the resin foam to return the deformation to the original state.

The resin foam of the present invention is formed by allowing a composition containing at least a resin (resin composition) to expand. In the present specification, the composition may be referred to as a “resin composition.” For example, when the resin foam of the present invention is a polyester resin foam, such a polyester resin foam is formed by allowing a composition containing at least a polyester resin (polyester resin composition) to expand. Note that the resin composition may comprise only a resin. For example, the polyester resin composition may comprise only a polyester resin.

The stress retention of the resin foam of the present invention is not less than 70%, preferably not less than 75%. Since the resin foam of the present invention has a stress retention of not less than 70%, it is excellent in deformation recovery performance after compressive deformation. For example, when the resin foam of the present invention is in a sheet form, it is excellent in the recovery performance of thickness even if it is deformed in the thickness direction of the resin foam.

The resin foam of the present invention has a cell structure. The cell structure of the resin foam of the present invention is preferably a semi-open/semi-closed cell structure in terms of obtaining more excellent flexibility, but is not particularly limited thereto. The semi-open/semi-closed cell structure is a cell structure containing both a closed cell moiety and an open cell moiety, and the ratio between the closed cell moiety and open cell moiety is not particularly limited. The resin foam of the present invention more preferably has a cell structure in which a closed cell moiety occupies not more than 40% (more preferably not more than 30%) of the resin foam.

The average cell diameter of the resin foam of the present invention is preferably 10 to 150 μm, more preferably 20 to 130 μm, further preferably 20 to 115 μm, further more preferably 30 to 100 μm, but is not particularly limited thereto. The average cell diameter is preferably not less than 10 μm because excellent flexibility can be easily obtained. Further, the average cell diameter is preferably not more than 150 μm because occurrence of pinholes and occurrence of coarse cells (voids) are suppressed, and excellent dustproofness and excellent shading properties are easily obtained.

The maximum cell diameter of the resin foam of the present invention is preferably less than 200 μm, more preferably not more than 190 μm, further preferably not more than 175 μm, but is not particularly limited thereto. When the maximum cell diameter is less than 200 μm, the resin foam does not contain coarse cells and is excellent in the uniformity of the cell structure. Therefore, the occurrence of a problem that dust enters from the coarse cells to reduce dustproofness can be suppressed, and excellent sealing properties and dustproofness can be easily obtained. Therefore, such a maximum cell diameter is preferred. It is also preferred in terms of easily obtaining excellent shading properties.

The resin foam of the present invention preferably has a uniform and fine cell structure in terms of flexibility, dustproofness, and shading properties, and it is particularly preferred that the average cell diameter be 10 to 150 μm, and the maximum cell diameter be less than 200 μm.

The cell diameter of cells in the cell structure of the resin foam of the present invention can be determined, for example, by capturing an enlarged image of a cell-structure portion in a cut surface with a digital microscope, determining the area of the cells by image analysis, and converting it to the equivalent circle diameter.

The apparent density of the resin foam of the present invention is preferably 0.01 to 0.15 g/cm³, more preferably 0.02 to 0.12 g/cm³, further preferably 0.03 to 0.10 g/cm³, but is not particularly limited thereto. The apparent density is preferably not less than 0.01 g/cm³ because satisfactory strength can be easily obtained. Further, the apparent density is preferably not more than 0.15 g/cm³ because a high expansion ratio is obtained, and excellent flexibility is easily obtained.

That is, when the resin foam of the present invention has an apparent density of 0.01 to 0.15 g/cm³, the resin foam will obtain better foaming characteristics (high expansion ratio) and easily exhibit proper strength, excellent flexibility, excellent cushioning properties, and excellent clearance adaptability. Therefore, the resin foam can not only follow fine clearance by having flexibility but also effectively increase dustproofness and shading properties.

In the resin foam of the present invention, the repulsive force at 50% compression to be defined below is preferably 0.1 to 4.0 N/cm², more preferably 0.2 to 3.5 N/cm², further preferably 0.3 to 3.0 N/cm², but is not particularly limited thereto.

Repulsive force at 50% compression: a repulsive load when a resin foam in a sheet form is compressed in the thickness direction so that the resin foam has a thickness of 50% of the initial thickness in an atmosphere of 23° C.

Note that in the present specification, the repulsive stress at 50% compression defined above may be simply referred to as “repulsive force at 50% compression.”

The repulsive force at 50% compression is preferably not more than 4.0 N/cm² because better flexibility is obtained. Further, when the repulsive force at 50% compression is not less than 0.1 N/cm², proper rigidity is easily obtained, which is preferred in terms of processability, workability, and the like.

Particularly, the resin foam of the present invention preferably has an average cell diameter of 10 to 150 μm, a maximum cell diameter of less than 200 μm, an apparent density of 0.01 to 0.15 g/cm³, and a repulsive force at 50% compression of 0.1 to 4.0 N/cm², in terms of flexibility, dustproofness, shading properties, processability, and strength.

The shape of the resin foam of the present invention is preferably a sheet form and a tape form, but is not particularly limited thereto. Further, the resin foam may also be processed into a suitable shape depending on the purpose of use. For example, it may also be processed into a linear shape, a round shape, a polygonal shape, or a frame shape (framed shape) by cutting, punching, or the like.

The thickness of the resin foam of the present invention is preferably 0.05 to 5.0 mm, more preferably 0.06 to 3.0 mm, further preferably 0.07 to 1.5 mm, further more preferably 0.08 to 1.0 mm, but is not particularly limited thereto.

The resin foam of the present invention contains at least a resin. For example, when the resin foam of the present invention is a polyester resin foam, it contains at least a polyester resin.

The resin which is a material of the resin foam of the present invention preferably includes a thermoplastic resin, but is not particularly limited thereto. The resin foam of the present invention may comprise one resin or may comprise not less than two resins. That is, the resin foam of the present invention is preferably formed by allowing a thermoplastic resin composition containing a thermoplastic resin to expand.

Examples of the thermoplastic resin include polyolefinic resins such as low density polyethylene, medium density polyethylene, high density polyethylene, linear low density polyethylene, polypropylene, a copolymer of ethylene and propylene, a copolymer of ethylene or propylene with other α-olefins (such as butene-1, pentene-1, hexene-1, and 4-methylpentene-1), a copolymer of ethylene and other ethylenic unsaturated monomers (such as vinyl acetate, acrylic acid, acrylate, methacrylic acid, methacrylate, and vinyl alcohol); styrenic resins such as polystyrene and an acrylonitrile-butadiene-styrene copolymer (ABS resin); polyamide resins such as 6-nylon, 66-nylon, and 12-nylon; polyamideimide; polyurethane; polyimide; polyether imide; acrylic resins such as polymethylmethacrylate; polyvinyl chloride; polyvinyl fluoride; alkenyl aromatic resin; polyester resins such as polyethylene terephthalate and polybutylene terephthalate; polycarbonate such as bisphenol A polycarbonate; polyacetal; and polyphenylene sulfide. Further, the thermoplastic resin may be used alone or in combination. Note that when the thermoplastic resin is a copolymer, it may be a copolymer in the form of a random copolymer or a block copolymer.

The thermoplastic resin also includes a rubber component and/or a thermoplastic elastomer component. Note that the resin foam of the present invention may be formed from a resin composition containing the thermoplastic resin and a rubber component and/or a thermoplastic elastomer component.

The rubber component or thermoplastic elastomer component is not particularly limited as long as it has rubber elasticity and can be expanded, and examples thereof include various thermoplastic elastomers such as natural or synthetic rubber such as natural rubber, polyisobutylene, polyisoprene, chloroprene rubber, butyl rubber, and nitrile butyl rubber; olefinic elastomers such as ethylene-propylene copolymers, ethylene-propylene-diene copolymers, ethylene-vinylacetate copolymers, polybutene, and chlorinated polyethylene; styrenic elastomers such as styrene-butadiene-styrene copolymers, styrene-isoprene-styrene copolymers, and hydrogenated polymers derived from them; polyester elastomers; polyamide elastomers; and polyurethane elastomers. Note that these rubber components and/or thermoplastic elastomer components may be used alone or in combination.

The thermoplastic resin is preferably polyester (polyester such as the polyester resin and the polyester elastomer as described above) in terms of capable of suppressing the occurrence of rupture and tearing when the resin foam is processed into a narrow width (for example, processed into a line width of about 1 mm), being excellent in shape retentivity, and being suitable for foam sealing materials. That is, the resin foam of the present invention is preferably a resin foam formed from a resin composition containing a polyester resin (polyester resin foam). Polyester resin has high strength and high elastic modulus among thermoplastic resins.

The polyester resin is not particularly limited as long as it is a resin having an ester binding site derived from a reaction (polycondensation) of a polyol component with a polycarboxylic acid component. Note that the polyester resin is used alone or in combination. Further, when the resin foam of the present invention is a polyester resin foam, such a polyester resin foam may contain other resins (resins other than a polyester resin) together with the polyester resin.

In the resin foam of the present invention such as the polyester resin foam, the resin such as a polyester resin is preferably contained in an amount of not less than 70% by weight (more preferably not less than 80% by weight) relative to the total amount (total weight, 100% by weight) of the resin foam.

The polyester resin preferably includes a polyester thermoplastic resin. The polyester resin preferably also includes a polyester thermoplastic elastomer. The polyester resin foam may be formed by allowing a polyester resin composition containing at least both a polyester thermoplastic resin and a polyester thermoplastic elastomer to expand.

Particularly, the polyester resin foam preferably contains the polyester thermoplastic elastomer in terms of obtaining a stress retention of not less than a predetermined value and obtaining satisfactory deformation recovery performance after compressive deformation. That is, the polyester resin foam is preferably a polyester thermoplastic elastomer foam formed by allowing a polyester resin composition containing at least a thermoplastic elastomer polyester to expand.

Examples of the polyester thermoplastic resin include, but are not particularly limited to, polyalkylene terephthalate resins such as polyethylene terephthalate, polytrimethylene terephthalate, polybutylene terephthalate, polyethylene naphthalate, polybutylene naphthalate, and polycyclohexane terephthalate. Other examples of the polyester thermoplastic resin also includes a copolymer obtained by copolymerizing two or more of the polyalkylene terephthalate resins. Note that when the polyalkylene terephthalate resin is a copolymer, it may be a copolymer in the form of a random copolymer, a block copolymer, or a graft copolymer.

Further, preferred examples of the polyester thermoplastic elastomer include, but are not limited to, a polyester thermoplastic elastomer obtained by polycondensation of an aromatic dicarboxylic acid (divalent aromatic carboxylic acid) with a diol component. Note that the polyester thermoplastic elastomer may be used alone or in combination.

Examples of the aromatic dicarboxylic acid include terephthalic acid, isophthalic acid, phthalic acid, naphthalene carboxylic acid (such as 2,6-naphthalene dicarboxylic acid, 1,4-naphthalene dicarboxylic acid), diphenyl ether dicarboxylic acid, and 4,4-biphenyl dicarboxylic acid. Note that the aromatic dicarboxylic acid may be used alone or in combination.

Further, examples of the diol component include aliphatic diols such as ethylene glycol, propylene glycol, trimethylene glycol, 1,4-butanediol (tetramethylene glycol), 2-methyl-1,3-propanediol, 1,5-pentanediol, 2,2-dimethyl-1,3-propanediol (neopentyl glycol), 1,6-hexanediol, 3-methyl-1,5-pentanediol, 2-methyl-2,4-pentanediol, 1,7-heptane diol, 2,2-diethyl-1,3-propanediol, 2-methyl-2-propyl-1,3-propanediol, 2-methyl-1,6-hexanediol, 1,8-octanediol, 2-butyl-2-ethyl-1,3-propanediol, 1,3,5-trimethyl-1,3-pentanediol, 1,9-nonanediol, 2,4-diethyl-1,5-pentanediol, 2-methyl-1,8-octanediol, 1,10-decanediol, 2-methyl-1,9-nonanediol, 1,18-octadecanediol, and dimer diol; alicyclic diols such as 1,4-cyclohexanediol, 1,3-cyclohexanediol, 1,2-cyclohexanediol, 1,4-cyclohexanedimethanol, 1,3-cyclohexanedimethanol, and 1,2-cyclohexanedimethanol; aromatic diols such as bisphenol A, an ethylene oxide adduct of bisphenol A, bisphenol S, an ethylene oxide adduct of bisphenol S, xylylene diol, and naphthalenediol; ether glycols such as diethylene glycol, triethylene glycol, tetraethylene glycol, polyethylene glycol, and dipropylene glycol. Note that the diol component may be a diol component in a polymer form such as a polyether diol and a polyester diol. Examples of the polyetherdiols include polyethylene glycol, polypropylene glycol, and polytetramethylene glycol obtained by ring opening polymerization of ethylene oxide, propylene oxide, and tetrahydrofuran, respectively, and polyetherdiols such as copolyethers obtained by copolymerization of these monomers. Further, the diol component may be used alone or in combination.

Further, preferred examples of the polyester thermoplastic elastomer include a polyester elastomer which is a block copolymer of a hard segment and a soft segment. In the polyester resin foam, a polyester resin having a high elastic modulus is preferred for obtaining a stress retention of not less than a specific value, and flexibility is also required. Therefore, a polyester elastomer having both of these properties which is a block copolymer of a hard segment and a soft segment is preferred.

Examples of such a polyester thermoplastic elastomer (polyester thermoplastic elastomer which is a block copolymer of a hard segment and a soft segment) include, but are not limited to, the following (i) to (iii).

(i) a polyester-polyester type copolymer containing, as a hard segment, a polyester formed by polycondensation of the aromatic dicarboxylic acid with a diol component having 2 to 4 carbon atoms between the hydroxyl groups in the main chain among the diol components and containing, as a soft segment, a polyester formed by polycondensation of the aromatic dicarboxylic acid with a diol component having 5 or more carbon atoms between the hydroxyl groups in the main chain among the diol components

(ii) a polyester-polyether type copolymer containing the same polyester as in the above (i) as a hard segment and containing a polyether such as the above polyetherdiols, aliphatic polyethers as a soft segment

(iii) a polyester-polyester type copolymer containing the same polyester as in the above (i) and (ii) as a hard segment and containing an aliphatic polyester as a soft segment

Particularly, the polyester thermoplastic elastomer is preferably a polyester elastomer which is a block copolymer of a hard segment and a soft segment, more preferably the above (ii) polyester-polyether type copolymer (a polyester-polyether type copolymer containing, as a hard segment, a polyester formed by polycondensation of an aromatic dicarboxylic acid with a diol component having 2 to 4 carbon atoms between the hydroxyl groups in the main chain, and containing a polyether as a soft segment).

More specific examples of the above (ii) polyester-polyether type copolymer include a polyester-polyether type block copolymer having polybutylene terephthalate as a hard segment and a polyether as a soft segment.

The melt flow rate (MFR) at 230° C. of a resin constituting the resin foam of the present invention (such as a polyester resin constituting a polyester resin foam) is preferably 1.5 to 4.0 g/10 min, more preferably 1.5 to 3.8 g/10 min, further preferably 1.5 to 3.5 g/10 min, but is not particularly limited thereto. The melt flow rate (MFR) at 230° C. of the resin is preferably not less than 1.5 g/10 min because the moldability of the resin composition is improved. For example, the resin composition can be preferably easily extruded from an extruder in a desired shape without clogging. Further, the melt flow rate (MFR) at 230° C. of the resin is preferably not more than 4.0 g/10 min because the variation in the cell diameter hardly occurs after the formation of a cell structure, and a uniform cell structure is easily obtained. Note that, in the present specification, the MFR at 230° C. refers to an MFR measured at a temperature of 230° C. and a load of 2.16 kgf based on IS01133 (JIS K 7210).

That is, the polyester resin foam is preferably formed by allowing a polyester resin composition containing at least a polyester resin having a melt flow rate (MFR) at 230° C. of 1.5 to 4.0 g/10 min to expand. Particularly, when the polyester resin foam is a polyester thermoplastic elastomer foam, the polyester resin foam is preferably formed by allowing a polyester resin composition containing at least a polyester thermoplastic elastomer (particularly, a polyester thermoplastic elastomer which is a block copolymer of a hard segment and a soft segment) having a melt flow rate (MFR) at 230° C. of 1.5 to 4.0 g/10 min to expand.

As described above, the polyester resin foam may contain other resins (resins other than the polyester resin) together with the polyester resin. Note that other resins may be used alone or in combination.

Examples of the above other resins include polyolefinic resins such as low density polyethylene, medium density polyethylene, high density polyethylene, linear low density polyethylene, polypropylene, a copolymer of ethylene and propylene, a copolymer of ethylene or propylene with other α-olefins (such as butene-1, pentene-1, hexene-1, and 4-methylpentene-1), a copolymer of ethylene and other ethylenic unsaturated monomers (such as vinyl acetate, acrylic acid, acrylate, methacrylic acid, methacrylate, and vinyl alcohol); styrenic resins such as polystyrene and an acrylonitrile-butadiene-styrene copolymer (ABS resin); polyamide resins such as 6-nylon, 66-nylon, and 12-nylon; polyamideimide; polyurethane; polyimide; polyether imide; acrylic resins such as polymethylmethacrylate; polyvinyl chloride; polyvinyl fluoride; alkenyl aromatic resin; polycarbonate such as bisphenol A polycarbonate; polyacetal; and polyphenylene sulfide. Note that when these resins are each a copolymer, it may be a copolymer in the form of a random copolymer or a block copolymer.

The resin composition forming the resin foam of the present invention preferably contains a foam nucleating agent. For example, the polyester resin composition forming the polyester resin foam preferably contains a foam nucleating agent. When the polyester resin composition contains a foam nucleating agent, a polyester resin foam in a good foamed state can be easily obtained. Note that the foam nucleating agent may be used alone or in combination.

The foam nucleating agent preferably includes an inorganic substance, but is not particularly limited thereto. Examples of the inorganic substance include hydroxides such as aluminum hydroxide, potassium hydroxide, calcium hydroxide, and magnesium hydroxide; clay (particularly hard clay); talc; silica; zeolite; alkaline earth metal carbonates such as calcium carbonate and magnesium carbonate; metal oxides such as zinc oxide, titanium oxide, and alumina; metal powder such as various metal powder such as iron powder, copper powder, aluminum powder, nickel powder, zinc powder, and titanium powder, and alloy powder; mica; carbon particles; glass fiber; carbon tubes; laminar silicates; and glass.

Especially, as the inorganic substance as a foam nucleating agent, clay and alkaline earth metal carbonates are preferred, and hard clay is more preferred, in terms of suppressing the occurrence of coarse cells and capable of easily obtaining a uniform and fine cell structure.

The hard clay is clay containing substantially no coarse particles. In particular, the hard clay is preferably clay having a residue on a 166 mesh sieve of not more than 0.01%, and more preferably clay having a residue on a 166 mesh sieve of not more than 0.001%. Note that the residue on sieve refers to the proportion (based on weight) of particles remaining on a sieve without passing through it when the particles are sieved to the total particles.

The hard clay includes aluminum oxide and silicon oxide as essential components. The proportion of the sum of the aluminum oxide and the silicon oxide in the hard clay is preferably not less than 80% by weight (for example, 80 to 100% by weight), more preferably not less than 90% by weight (for example, 90 to 100% by weight) relative to the total amount (100% by weight) of the hard clay. Further, the hard clay may be fired.

The average particle size of the hard clay is preferably 0.1 to 10 μm, more preferably 0.2 to 5.0 μm, further preferably 0.5 to 1.0 μm, but is not limited thereto.

Further, the inorganic substance is preferably subjected to surface treatment. That is, the foam nucleating agent is preferably a surface-treated inorganic substance. Examples of surface treatment agents used for the surface treatment of the inorganic substance preferably include, but are not particularly limited to, aluminum compounds, silane compounds, titanate compounds, epoxy compounds, isocyanate compounds, higher fatty acids or salts thereof, and phosphoric esters, more preferably include silane compounds (particularly, silane coupling agents) and higher fatty acids or salts thereof (particularly, stearic acid), in terms of obtaining such an effect that application of surface treatment improves compatibility with a resin (particularly, polyester resin) to thereby prevent occurrence of voids during expansion, molding, kneading, drawing, or the like or prevent rupture of cells during expansion. Note that the surface treatment agent may be used alone or in combination.

That is, it is particularly preferred that the surface treatment of the inorganic substance be silane coupling treatment or treatment with a higher fatty acid or a salt thereof.

The aluminum compound is preferably, but not limited to, an aluminate coupling agent. Examples of the aluminate coupling agent include acetoalkoxy aluminum diisopropylate, aluminum ethylate, aluminum isopropylate, mono-sec-butoxy aluminum diisopropylate, aluminum sec-butyrate, ethyl acetoacetate aluminum diisopropylate, aluminum tris(ethyl acetoacetate), aluminum mono-acetylacetonate bis(ethyl acetoacetate), aluminum tris(acetylacetonate), a cyclic aluminum oxide isopropylate, and a cyclic aluminum oxide isostearate.

The silane compound is preferably, but not limited to, a silane coupling agent. Examples of the silane coupling agent include a vinyl group-containing silane coupling agent, a (meth)acryloyl group-containing silane coupling agent, an amino group-containing silane coupling agent, an epoxy group-containing silane coupling agent, a mercapto group-containing silane coupling agent, a carboxyl group-containing silane coupling agent, and a halogen atom-containing silane coupling agent. Specific examples of the silane coupling agent include vinyltrimethoxysilane, vinylethoxysilane, dimethylvinylmethoxysilane, dimethylvinylethoxysilane, methylvinyldimethoxysilane, methylvinyldiethoxysilane, vinyl-tris(2-methoxy)silane, vinyltriacetoxysilane, 2-methacryloxyethyltriethoxysilane, 3-methacryloxypropyltrimethoxysilane, 3-methacryloxypropyltriethoxysilane, 3-methacryloxypropylmethyldimethoxysilane, 3-aminopropyltrimethoxysilane, 3-aminopropyltriethoxysilane, 2-aminoethyltrimethoxysilane, 3-[N-(2-aminoethyl)amino]propyltrimethoxysilane, 3-[N-(2-aminoethyl)amino]propyltriethoxysilane, 2-[N-(2-aminoethyl)amino]ethyltrimethoxysilane, 2-(3,4-epoxycyclohexyl)ethyltrimethoxysilane, 2-(3,4-epoxycyclohexyl)ethyltriethoxysilane, 3-glycidoxypropyltrimethoxysilane, 3-glycidoxypropylmethyldiethoxysilane, 2-glycidoxyethyltrimethoxysilane, 2-glycidoxyethyltriethoxysilane, 3-mercaptopropyltrimethoxysilane, carboxymethyltriethoxysilane, 3-carboxypropyltrimethoxysilane, and 3-carboxypropyltriethoxysilane.

The titanate compound is preferably, but not limited to, a titanate coupling agent. Examples of the titanate coupling agent include isopropyl triisostearoyl titanate, isopropyl tris(dioctylpyrophosphate)titanate, isopropyl tri(N-aminoethyl-aminoethyl)titanate, isopropyl tridecylbenzenesulphonyl titanate, tetraisopropyl bis(dioctylphosphite)titanate, tetraoctyl bis(ditridecylphosphite)titanate, tetra(2,2-diallyloxymethyl-1-butyl)bis(di-tridecyl)phosphite titanate, bis(dioctylpyrophosphate)oxyacetate titanate, bis(dioctylpyrophosphate)ethylene titanate, isopropyl trioctanoyl titanate, isopropyl dimethacryl isostearoyl titanate, isopropyl isostearoyl diacryl titanate, isopropyl tri(dioctylphosphate)titanate, isopropyl tricumylphenyl titanate, dicumylphenyloxyacetate titanate, and diisostearoylethylene titanate.

The epoxy compound is preferably, but not limited to, an epoxy resin and a mono-epoxy compound. Examples of the epoxy resin include a glycidyl ether type epoxy resin such as a bisphenol A type epoxy resin, a glycidyl ester type epoxy resin, a glycidyl amine type epoxy resin, and an alicyclic epoxy resin. Further, examples of the mono-epoxy compound include styrene oxide, glycidyl phenyl ether, allyl glycidyl ether, glycidyl (meth)acrylate, 1,2-epoxycyclohexane, epichlorohydrin, and glycidol.

The isocyanate compound is preferably, but not limited to, a polyisocyanate compound and a monoisocyanate compound. Examples of the polyisocyanate compound include an aliphatic diisocyanate such as tetramethylene diisocyanate and hexamethylene diisocyanate; an alicyclic diisocyanate such as isophorone diisocyanate and 4,4′-dicyclohexylmethane diisocyanate; an aromatic diisocyanate such as diphenylmethane diisocyanate, 2,4-tolylene diisocyanate, 2,6-tolylene diisocyanate, phenylene diisocyanate, 1,5-naphthylene diisocyanate, xylylene diisocyanate, and toluylene diisocyanate; and a polymer having a free isocyanate group derived from a reaction of the above diisocyanate compound with a polyol compound. Further, examples of the monoisocyanate compound include phenyl isocyanate and stearyl isocyanate.

Examples of the higher fatty acid or a salt thereof include a higher fatty acid such as oleic acid, stearic acid, palmitic acid, and lauric acid, and a salt (for example, a metal salt and the like) of the higher fatty acid. Examples of the metal atom in the metal salt of the higher fatty acid include an alkali metal atom such as a sodium atom and a potassium atom and an alkali earth metal atom such as a magnesium atom and a calcium atom.

The phosphoric acid esters are preferably phosphoric acid partial esters. Examples of the phosphoric acid partial esters include a phosphoric acid partial ester in which phosphoric acid (orthophosphoric acid or the like) is partially esterified (mono- or di-esterified) with an alcohol component (stearyl alcohol or the like) and a salt (such as a metal salt with an alkali metal or the like) of the phosphoric acid partial ester.

Examples of the process for the surface treatment of the inorganic substances with the surface treatment agent include, but are not limited to, a dry process, a wet process, and an integral blending process. Further, the amount of the surface treatment agent in the surface treatment of the inorganic substance with the surface treatment agent is preferably 0.1 to 10 parts by weight, more preferably 0.3 to 8 parts by weight relative to 100 parts by weight of the above inorganic substance, but is not limited thereto.

Further, the residue on a 166 mesh sieve of the inorganic substance is preferably not more than 0.01%, more preferably not more than 0.001%, but is not limited thereto. This is because if coarse particles are present when the resin composition (for example, the polyester resin composition) is allowed to expand, the rupture of cells can easily occur. This is because the size of the particles exceeds the thickness of the cell wall.

The average particle size of the inorganic substance is preferably 0.1 to 10 μm, more preferably 0.2 to 5.0 μm, further preferably 0.5 to 1.0 μm, but is not limited thereto. If the average particle size is less than 0.1 μm, the inorganic substance may not sufficiently function as a nucleating agent. On the other hand, if the average particle size exceeds 10 μm, it may cause outgassing during foaming of the resin composition such as the polyester resin composition. Therefore, these average particle sizes are not preferred.

Particularly, the foam nucleating agent is preferably a surface-treated inorganic substance (particularly, a surface-treated hard clay), in terms of compatibility with a resin (for example, compatibility with a polyester resin) and capable of easily obtaining a fine cell structure by suppressing the foam rupture during foaming due to the occurrence of voids at the interface between a resin and an inorganic substance (for example, the occurrence of voids at the interface between a polyester resin and an inorganic substance).

The content of the foam nucleating agent in the resin composition is not particularly limited. For example, the content of the foam nucleating agent in the polyester resin composition is preferably 0.1 to 20% by weight, more preferably 0.3 to 10% by weight, further preferably 0.5 to 6% by weight, relative to the total amount (100% by weight) of the polyester resin composition, but is not limited thereto. The content is preferably not less than 0.1% by weight because a site for forming cells (cell-forming site) can be sufficiently ensured, and a fine cell structure is easily obtained. Further, the content is preferably not more than 20% by weight because a significant increase in the viscosity of a polyester resin composition can be suppressed; outgassing during the foaming of a polyester resin composition can be suppressed; and a uniform cell structure is easily obtained.

Further, the resin composition may contain a modified polymer. For example, the polyester resin composition preferably contains an epoxy-modified polymer. The epoxy-modified polymer acts as a crosslinking agent. It also acts as a modifier (resin modifier) for improving the melt tension and the degree of strain hardening of the polyester resin composition (particularly, the polyester resin composition containing a polyester elastomer). For this reason, it is preferred that the polyester resin composition contain an epoxy-modified polymer because, in this case, a stress retention of not less than a predetermined value is obtained, and excellent deformation recovery performance is easily obtained. The polyester resin composition preferably contains an epoxy-modified polymer also because a highly-expanded fine cell structure is easily obtained. Note that the modified polymer such as an epoxy-modified polymer may be used alone or in combination.

The epoxy-modified polymer is preferably, but not particularly limited to, at least one polymer selected from an epoxy-modified acrylic polymer which is a polymer having an epoxy group in a terminal of the main chain and a side chain of an acrylic polymer and an epoxy-modified polyethylene which is a polymer having an epoxy group in a terminal of the main chain and a side chain of polyethylene, in terms of hardly forming a three-dimensional network as compared with a low molecular weight compound having an epoxy group and capable of easily obtaining the polyester resin composition excellent in melt tension and the degree of strain hardening.

The weight average molecular weight of the epoxy-modified polymer is preferably 5,000 to 100,000, more preferably 8,000 to 80,000, further preferably 10,000 to 70,000, particularly preferably 20,000 to 60,000, but is not particularly limited thereto. Note that if the molecular weight is less than 5,000, the reactivity of the epoxy-modified polymer may increase, and the polyester resin composition may not be highly expanded.

The epoxy equivalent of the epoxy-modified polymer is preferably 100 to 3000 g/eq, more preferably 200 to 2500 g/eq, further preferably 300 to 2000 g/eq, particularly preferably 800 to 1600 g/eq, but is not particularly limited thereto. The epoxy equivalent of the epoxy-modified polymer is preferably not more than 3000 g/eq because the melt tension and the degree of strain hardening of the polyester resin composition are sufficiently improved to obtain a stress retention of not less than a predetermined value, and excellent deformation recovery performance is easily obtained. Further, the above epoxy equivalent is preferred because a highly-expanded fine cell structure is easily obtained. Further, the epoxy equivalent of the epoxy-modified polymer is preferably not less than 100 g/eq because this can suppress a problem that the reactivity of the epoxy-modified polymer is increased to excessively increase the viscosity of the polyester resin composition to prevent the polyester resin composition from being highly expanded.

The viscosity (B type viscosity, 25° C.) of the epoxy-modified polymer is preferably 2000 to 4000 mPa·s, more preferably 2500 to 3200 mPa·s, but is not particularly limited thereto. The viscosity of the epoxy-modified polymer is preferably not less than 2000 mPa·s because the failure of the cell wall during foaming of the polyester resin composition is suppressed, and a highly-expanded fine cell structure is easily obtained. On the other hand, the viscosity is preferably not more than 4000 mPa·s because the fluidity of the polyester resin composition is easily obtained, and the polyester resin composition can be efficiently expanded.

Particularly, the epoxy-modified polymer preferably has a weight average molecular weight of 5,000 to 100,000 and an epoxy equivalent of 100 to 3000 g/eq.

When the resin composition contains a modified polymer, the content of the modified polymer is not particularly limited. For example, the content of the epoxy-modified polymer in the polyester resin composition is preferably 0.5 to 15.0 parts by weight, more preferably 0.6 to 10.0 parts by weight, further preferably 0.7 to 7.0 parts by weight, further more preferably 0.8 to 3.0 parts by weight, relative to 100 parts by weight of the polyester resin, but is not particularly limited thereto. The content of the epoxy-modified polymer is preferably not less than 0.5 parts by weight because the melt tension and the degree of strain hardening of the polyester resin composition can be increased to obtain a stress retention of not less than a predetermined value, and excellent deformation recovery performance is easily obtained. Further, the above content is preferred because a highly-expanded fine cell structure is easily obtained. Further, the content of the epoxy-modified polymer is preferably not more than 15.0 parts by weight because this can suppress a problem that the viscosity of the polyester resin composition is excessively increased to prevent the composition from being highly expanded, and a highly-expanded fine cell structure is easily obtained.

Note that the epoxy-modified polymer can further improve the melt tension of the polyester resin composition because the polymer can inhibit the cleavage of a polyester chain by hydrolysis (for example, hydrolysis resulting from moisture absorption of a raw material), thermal decomposition, oxidative decomposition, and the like, and can recombine the cleaved polyester chain. Further, since the epoxy-modified polymer has a large number of epoxy groups in a molecule, it can more easily allow a branched structure to be formed than a conventional epoxy crosslinking agent, and can further improve the degree of strain hardening of the polyester resin composition.

Further, the resin composition preferably contains a lubricant. For example, the polyester resin composition preferably contains a lubricant. The resin composition such as the polyester resin composition preferably contains a lubricant because the moldability of the resin composition is improved. The resin composition preferably has improved slidability and, for example, can be preferably easily extruded from an extruder into a desired shape without clogging. Note that the lubricant may be used alone or in combination.

Examples of the lubricant include, but are not particularly limited to, aliphatic carboxylic acids and derivatives thereof (for example, aliphatic carboxylic acid anhydrides, alkali metal salts of aliphatic carboxylic acids, and alkaline earth metal salts of aliphatic carboxylic acids). Among the aliphatic carboxylic acids and derivatives thereof, especially preferred are aliphatic carboxylic acids having 3 to 30 carbon atoms such as lauryl acid and derivatives thereof, stearic acid and derivatives thereof, crotonic acid and derivatives thereof, oleic acid and derivatives thereof, maleic acid and derivatives thereof, glutaric acid and derivatives thereof, behenic acid and derivatives thereof, and montanic acid and derivatives thereof. Further, among the aliphatic carboxylic acids having 3 to 30 carbon atoms and derivatives thereof, stearic acid and derivatives thereof and montanic acid and derivatives thereof are preferred, and alkali metal salts of stearic acid and alkaline earth metal salts of stearic acid are particularly preferred, in terms of dispersibility and solubility in the resin composition and the effect of improvement in surface appearance. Furthermore, zinc stearate and calcium stearate are more suitable among alkali metal salts of stearic acid and alkaline earth metal salts of stearic acid.

In addition, the lubricant includes an acrylic lubricant. Examples of commercially available products of the acrylic lubricant include an acrylic polymer external lubricant (trade name “Metablen L”, supplied by Mitsubishi Rayon Co., Ltd.).

Particularly, an acrylic lubricant is preferred as the lubricant.

When the resin composition contains a lubricant, the content of the lubricant is not particularly limited. For example, the content of the lubricant in the polyester resin composition is preferably 0.1 to 20 parts by weight, more preferably 0.3 to 10 parts by weight, further preferably 0.5 to 8 parts by weight, relative to 100 parts by weight of the polyester resin, but is not particularly limited thereto. The content of the lubricant is preferably not less than 0.1 parts by weight because it is easy to obtain the effect obtained by containing the lubricant. On the other hand, the content of the lubricant is preferably not more than 20 parts by weight because this suppresses the omission of cells when the polyester resin composition is allowed to expand, and can suppress a problem that the polyester resin composition cannot be highly expanded.

Further, a crosslinking agent may be contained in the resin composition within the range that does not impair the effects of the present invention. For example, the polyester resin composition may contain a crosslinking agent within the range which does not prevent the effects of the present invention. Examples of the crosslinking agent include, but not limited to, an epoxy crosslinking agent, an isocyanate crosslinking agent, a silanol crosslinking agent, a melamine resin crosslinking agent, a metal salt crosslinking agent, a metal chelate crosslinking agent, and an amino resin crosslinking agent. Note that the crosslinking agent may be used alone or in combination.

The resin composition may further contain a crystallization promoter within the range which does not prevent the effects of the present invention. For example, a crystallization promoter may be contained in the polyester resin composition within the range that does not impair the effects of the present invention. Examples of the crystallization promoter include, but are not particularly limited to, an olefinic resin. Preferred ones among such olefinic resins include a resin of a type having a wide molecular weight distribution with a shoulder on the high molecular weight side, a slightly crosslinked type resin (a resin of a type crosslinked a little), and a long-chain branched type resin. Examples of the olefinic resins include low density polyethylene, medium density polyethylene, high density polyethylene, linear low density polyethylene, polypropylene, a copolymer of ethylene and propylene, a copolymer of ethylene or propylene and another alpha olefin (such as butene-1, pentene-1, hexene-1, and 4-methylpentene-1), and a copolymer of ethylene and another ethylenic unsaturated monomer (such as vinyl acetate, acrylic acid, acrylate, methacrylic acid, methacrylate, and vinyl alcohol). Note that when the olefinic resin is a copolymer, the copolymer may be in either form of a random copolymer or a block copolymer. Further, the olefinic resin may be used alone or in combination.

Further, the resin composition may contain a flame retardant within the range that does not impair the effects of the present invention. For example, the polyester resin composition may contain a flame retardant within the range that does not impair the effects of the present invention. This is because although the polyester resin foam of the present invention has the characteristics of easy burning since it contains a polyester resin, the polyester resin foam may be used for applications in which it is indispensable to impart flame retardancy such as electric appliance or electronic appliance application. Examples of the flame retardant include, but are not particularly limited to, powder particles having flame retardancy (such as various powdery flame retardants), and preferably include inorganic flame retardants. Examples of the inorganic flame retardants may include brominated flame retardants, chlorine-based flame retardants, phosphorus flame retardants, and antimony flame retardants. However, chlorine-based flame retardants and brominated flame retardants generate a gas component which is harmful to a human body and corrosive to equipment when it burns, and phosphorus flame retardants and antimony flame retardants have problems such as harmfulness and explosibility. Therefore, non-halogen non-antimony inorganic flame retardants (inorganic flame retardants in which halogenated compounds and antimony compounds are not contained) are preferred. Examples of the non-halogen non-antimony inorganic flame retardants include hydrated metal compounds such as aluminum hydroxide, magnesium hydroxide, a magnesium oxide/nickel oxide hydrate, and a magnesium oxide/zinc oxide hydrate. Note that the hydrated metal oxides may be surface-treated. The flame retardant may be used alone or in combination.

Further, the following additives may be optionally contained in the resin composition within the range that does not impair the effects of the present invention. For example, the polyester resin composition may optionally contain the following additives within the range which does not prevent the effects of the present invention. Examples of such additives include crystal nucleators, plasticizers, colorants (for example, carbon black aiming at black color, pigments, and dyestuffs, and the like), ultraviolet absorbers, antioxidants, age inhibitors, reinforcements, antistatic agents, surfactants, tension modifiers, shrink resistant agents, fluidity improving agents, vulcanizing agents, surface-treating agents, dispersing aids, and polyester resin modifiers. Further, the additives may be used alone or in combination.

Particularly, the polyester resin composition preferably contains at least the following (i) to (ii) in terms of the ease of obtaining a polyester resin foam having a stress retention of not less than a predetermined value.

(i): a polyester thermoplastic elastomer having a melt flow rate (MFR) at 230° C. of 1.5 to 4.0 g/10 min (preferably a polyester thermoplastic elastomer having a melt flow rate (MFR) at 230° C. of 1.5 to 4.0 g/10 min which is a block copolymer of a hard segment and a soft segment, more preferably a polyester-polyether type copolymer having a melt flow rate (MFR) at 230° C. of 1.5 to 4.0 g/10 min and containing, as a hard segment, a polyester formed by polycondensation of an aromatic dicarboxylic acid with a diol component having 2 to 4 carbon atoms between the hydroxyl groups in the main chain, and containing a polyether as a soft segment)

(ii): a foam nucleating agent (preferably a surface-treated inorganic substance, more preferably a surface-treated hard clay)

The polyester resin composition is prepared, for example, by mixing the resin, the additives optionally added, and the like. The way to prepare the composition, however, is not limited to this. Note that heat may be applied at the time of the preparation.

The melt tension (take-up speed: 2.0 m/min) of the resin composition such as the polyester resin composition is preferably 13 to 70 cN, more preferably 15 to 60 cN, further preferably 15 to 55 cN, further more preferably 26 to 50 cN, but is not particularly limited thereto. The melt tension is preferably not less than 13 cN because when the resin composition is allowed to expand, a large expansion ratio is obtained; closed-cells are easily formed; and the shape of the cells formed is easily uniformized. On the other hand, the melt tension is preferably not more than 70 cN because good fluidity is easily obtained, and thus, bad influence to foaming due to reduction in fluidity can be suppressed.

Note that the melt tension refers to a tension obtained when a molten resin extruded at a specified temperature and extrusion speed from a specified die using a specified apparatus is taken up into a strand shape at a specified take-up speed. In the present invention, the melt tension is defined as a value obtained when a resin extruded at a constant speed of 8.8 mm/min from a capillary having a diameter of 2 mm and a length of 20 mm using Capillary Extrusion Rheometer supplied from Malvern Instruments Ltd. is taken up at a take-up speed of 2 m/min.

Note that the melt tension is a value measured at a temperature that is higher by 10±2° C. than the melting point of the resin in the resin composition. This is because the resin will not be in a molten state at a temperature less than the melting point; on the other hand, the resin will be in a complete liquid state at a temperature that is significantly higher than the melting point; and the melt tension cannot be measured.

The degree of strain hardening (strain rate: 0.1 [1/s]) of the resin compositions such as the polyester resin composition is preferably 2.0 to 5.0, more preferably 2.5 to 4.5, in terms of obtaining a uniform and dense cell structure and suppressing rupture of cells during the expansion to obtain a highly expanded foam, but is not particularly limited thereto. Further, the degree of strain hardening of the resin composition is the degree of strain hardening at the melting point of the resin in the resin composition. Note that the degree of strain hardening is an index showing the degree of the increase in the uniaxial elongational viscosity in the measurement of the uniaxial elongational viscosity, in the region (nonlinear region) where the uniaxial elongational viscosity has risen, separated from the region (linear region) where the uniaxial elongational viscosity gradually increases with the increase in strain after starting the measurement.

The resin foam of the present invention is preferably formed by allowing the resin composition to expand. For example, the polyester resin foam is preferably formed by allowing the polyester resin composition to expand. A process for foaming the resin composition such as the polyester resin composition preferably includes, but is not limited to, a foaming process comprising impregnating the resin composition such as the polyester resin composition with a high-pressure gas (particularly inert gas to be described below) and then subjecting the impregnated resin composition to decompression (pressure relief). That is, the resin foam of the present invention is preferably formed through the steps of impregnating the resin composition with a high-pressure gas (particularly inert gas to be described below) and then subjecting the impregnated resin composition to decompression. For example, the polyester resin foam is preferably formed through the steps of impregnating the polyester resin composition with a high-pressure gas (particularly inert gas to be described below) and then subjecting the impregnated polyester resin composition to decompression.

Inert gas is preferred as the gas. The inert gas refers to a gas which is inert to the polyester resin composition and with which the polyester resin composition can be impregnated. Examples of the inert gas include, but are not limited to, carbon dioxide (carbonic acid gas), nitrogen gas, helium, and air. These gases may be mixed and used. Among these, carbon dioxide is preferred in that it can be impregnated in a large amount and at a high rate into the resin composition.

Note that the process for foaming the resin composition such as the polyester resin composition includes a physical foaming technique (foaming process using a physical technique) and a chemical foaming technique (foaming process using a chemical technique). If foaming is performed according to the physical technique, there may occur problems about the combustibility, toxicity, and influence on the environment such as ozone layer depletion of the substance used as a blowing agent (blowing agent gas). However, the foaming technique using an inert gas is an environmentally friendly technique in that the blowing agent as described above is not used. If foaming is performed according to the chemical technique, a residue of a blowing gas produced from the blowing agent remains in the foam. This may cause a trouble of contamination by a corrosive gas or impurities in the gas especially in electronic appliances where suppression of contamination is highly needed. However, according to the foaming technique using an inert gas, a clean foam without such impurities and the like can be obtained. In addition, the physical and chemical foaming techniques are believed to be difficult to give a micro cell structure and to be very difficult to give micro cells of not more than 300 μm.

Further, from the viewpoint of increasing the rate of impregnation into the resin composition such as the polyester resin composition, the gas (particularly inert gas) is preferably in a supercritical state. Such gas in a supercritical state shows increased solubility in the resin composition such as the polyester resin composition and can be incorporated therein in a higher concentration. In addition, because of its high concentration, the supercritical gas generates a larger number of cell nuclei upon an abrupt pressure drop after impregnation. These cell nuclei grow to give cells, which are present in a higher density than in a foam having the same porosity but produced with the gas in another state. Consequently, use of a supercritical gas can give micro cells. Note that the critical temperature and critical pressure of carbon dioxide are 31° C. and 7.4 MPa, respectively.

As described above, the resin foam of the present invention is preferably produced by impregnating the resin composition with a high-pressure gas. The production may be performed by a batch system or continuous system. In the batch system, the resin composition is previously molded into an unfoamed resin molded article (unfoamed molded article) in an adequate form such as a sheet form, and then the unfoamed resin molded article is impregnated with a high-pressure gas, and the unfoamed resin molded article is then released from the pressure to allow the molded article to expand. In the continuous system, the polyester resin composition is kneaded under a pressure together with a high-pressure gas, and the kneaded mixture is molded into a molded article and, simultaneously, is released from the pressure. Thus, molding and foaming are performed simultaneously in the continuous system.

A case where the resin foam of the present invention is produced by a batch system will be described. In the batch system, an unfoamed resin molded article is first produced when the resin foam is produced. Examples of the process for producing the unfoamed resin molded article include, but are not particularly limited to, a process in which the resin composition is extruded with an extruder such as a single-screw extruder or twin-screw extruder; a process in which the resin composition is uniformly kneaded beforehand with a kneading machine equipped with one or more blades typically of a roller, cam, kneader, or Banbury type, and the resulting mixture is press-molded typically with a hot-plate press to thereby produce an unfoamed resin molded article having a predetermined thickness; and a process in which the polyester resin composition is molded with an injection molding machine. It is preferred to select a suitable process to give an unfoamed resin molded article having a desired shape and thickness among these processes. Note that the unfoamed resin molded article may be produced by other forming process in addition to extrusion, press molding, and injection molding. Further, with respect to the shape of the unfoamed resin molded article, various shapes are selected depending on applications, in addition to a sheet form. Examples of the shape include a sheet form, roll form, prism form, and plate form. Next, cells are formed through a gas impregnation step of putting the unfoamed resin molded article (molded article of the resin composition) in a pressure-tight vessel (high pressure vessel) and injecting (introducing) a high-pressure gas to impregnate the unfoamed resin molded article with the high-pressure gas; a decompression step of releasing the pressure (typically, to atmospheric pressure) when the unfoamed resin molded article is sufficiently impregnated with the high-pressure gas to allow cell nuclei to be generated in the unfoamed resin molded article; and optionally (where necessary) a heating step of heating the unfoamed resin molded article to allow the cell nuclei to grow. Note that the cell nuclei may be allowed to grow at room temperature without providing the heating step. After the cells are allowed to grow in this way, the unfoamed resin molded article is rapidly cooled with cold water as needed to fix its shape to yield the resin foam. Note that the introduction of the high-pressure gas may be performed continuously or discontinuously. The heating for the growth of cell nuclei can be performed according to a known or common procedure such as heating with a water bath, oil bath, hot roll, hot-air oven, far-infrared rays, near-infrared rays, or microwaves.

That is, the resin foam of the present invention may be formed by allowing it to expand through the steps of impregnating the unfoamed molded article comprising the resin composition with a high-pressure gas (particularly inert gas) and then subjecting the impregnated unfoamed molded article to decompression. Further, the resin foam of the present invention may be formed through the steps of impregnating the unfoamed molded article comprising the resin composition with a high-pressure gas (particularly inert gas) and then subjecting the impregnated unfoamed molded article to decompression, followed by heating the decompressed molded article. For example, the polyester resin foam of the present invention may be formed by allowing it to expand through the steps of impregnating the unfoamed molded article comprising the polyester resin composition with a high-pressure gas (particularly inert gas) and then subjecting the impregnated unfoamed molded article to decompression. Further, the polyester resin foam of the present invention may be formed through the steps of impregnating the unfoamed molded article comprising the polyester resin composition with a high-pressure gas (particularly inert gas) and then subjecting the impregnated unfoamed molded article to decompression, followed by heating the decompressed molded article.

On the other hand, examples of the case where the resin foam is produced by a continuous system include the production by a kneading/impregnation step of kneading the resin composition with an extruder such as a single-screw extruder or twin-screw extruder and, during this kneading, injecting (introducing) a high-pressure gas to impregnate the resin composition with the gas sufficiently; and a subsequent molding/decompression step of extruding the resin composition through a die arranged at a distal end of the extruder to thereby release the pressure (typically, to atmospheric pressure) to perform molding and foaming simultaneously. Optionally (where necessary), a heating step may be further provided to enhance cell growth by heating. After the cells are allowed to grow in this way, the resin composition is rapidly cooled with cold water as needed to fix its shape to yield the resin foam. Note that, in the kneading/impregnation step and molding/decompression step, an injection molding machine or the like may be used in addition to an extruder.

That is, the resin foam of the present invention may be formed by allowing it to expand through the steps of impregnating the molten resin composition with a high-pressure gas (particularly inert gas) and then subjecting the impregnated resin composition to decompression. Further, the resin foam of the present invention may be formed through the steps of impregnating the molten resin composition with a high-pressure gas (particularly inert gas) and then subjecting the impregnated resin composition to decompression, followed by heating the decompressed resin composition. For example, the polyester resin foam may be formed by allowing it to expand through the steps of impregnating the molten polyester resin composition with a high-pressure gas (particularly inert gas) and then subjecting the impregnated polyester resin composition to decompression. Further, the polyester resin foam may be formed through the steps of impregnating the molten polyester resin composition with a high-pressure gas (particularly inert gas) and then subjecting the impregnated polyester resin composition to decompression, followed by heating the decompressed polyester resin composition.

In the gas impregnation step in the batch system or in the kneading/impregnation system in the continuous system, the amount of the gas (particularly inert gas) to be incorporated into the resin composition is not particularly limited, but in the case of the polyester resin composition, the amount is preferably 1 to 10% by weight, more preferably 2 to 8% by weight, relative to the total amount of the polyester resin composition (100% by weight).

In the gas impregnation step in the batch system or in the kneading/impregnation step in the continuous system, the pressure at which the unfoamed resin molded article or the resin composition such as the polyester resin composition is impregnated with a gas is preferably not less than 3 MPa (for example, 3 to 100 MPa), more preferably not less than 4 MPa (for example, 4 to 100 MPa). If the pressure of the gas is lower than 3 MPa, considerable cell growth may occur during foaming, and this may tend to result in too large cell diameters and hence in disadvantages such as insufficient dustproofing effect and shading effect. Therefore, the pressure of the gas lower than 3 MPa is not preferred. The reasons for this are as follows. When impregnation is performed at a low pressure, the amount of gas impregnated is relatively small and cell nuclei are formed at a lower rate as compared with impregnation at higher pressures. As a result, the number of cell nuclei formed is smaller. Because of this, the gas amount per cell increases rather than decreases, resulting in excessively large cell diameters. Furthermore, in a region of pressures lower than 3 MPa, only a slight change in impregnation pressure results in considerable changes in cell diameter and cell density, and this may often impede the control of cell diameter and cell density.

Further, in the gas impregnation step in the batch system or in the kneading/impregnation system in the continuous system, the temperature at which the unfoamed resin molded article or the resin composition such as the polyester resin composition is impregnated with a high-pressure gas (particularly inert gas) can be selected within a wide range. When impregnation operability and other conditions are taken into account, the impregnation temperature is preferably 10° C. to 350° C. For example, when an unfoamed resin molded article in a sheet form is impregnated with a high-pressure gas (particularly inert gas) in the batch system, the impregnating temperature is preferably 40 to 300° C., more preferably 100 to 250° C. Further, when a high-pressure gas (particularly inert gas)) is injected into and kneaded with the resin composition such as the polyester resin composition in the continuous system, the impregnation temperature is preferably 150 to 300° C., more preferably 210 to 250° C. Note that when carbon dioxide is used as a high-pressure gas, it is preferred to impregnate the gas at a temperature (impregnation temperature) of 32° C. or higher (particularly 40° C. or higher), in order to maintain its supercritical state.

Note that, in the decompression step, the decompression rate is preferably 5 to 300 MPa/s in order to obtain uniform micro cells, but is not particularly limited thereto. Further, the heating temperature in the heating step is preferably 40 to 250° C., more preferably 60 to 250° C., but is not particularly limited thereto.

Further, a resin foam having a high expansion ratio can be produced according to the process for producing the resin foam, and therefore, a thick resin foam can be obtained. For example, a polyester resin foam having a high expansion ratio can be produced according to the above process for producing the resin foam, and therefore, a thick polyester resin foam can be obtained. When the resin foam is produced by the continuous system, it is necessary to regulate the gap in the die at the tip of the extruder so as to be as narrow as possible (generally 0.1 to 1.0 mm) for maintaining the pressure in the extruder in the kneading/impregnation step. This means that for obtaining a thick resin foam, the resin composition which has been extruded through such narrow gap should be foamed at a high expansion ratio. In the known techniques in use, however, a high expansion ratio is not obtained and the resulting foam has been limited to thin one (for example, one having a thickness of 0.5 to 2.0 mm). In contrast, the process for producing the resin foam using a high-pressure gas (particularly inert gas) can continuously produce a resin foam having a final thickness of 0.30 to 5.00 mm.

Since the resin foam of the present invention such as the polyester resin foam has a stress retention of not less than a predetermined value, it not only has flexibility but is excellent in deformation recovery performance after compressive deformation. In other words, since the resin foam of the present invention has a high stress recovery factor after compressive deformation, it easily exhibits a force to return to the original thickness, and as a result, it is excellent in the thickness recovery performance after compressive deformation.

Since the resin foam of the present invention such as the polyester resin foam has the above characteristics, it is suitably used as a sealing material and a dustproofing material for electric appliances, electronic appliances, or the like. Further, it is suitably used as a cushioning material and a shock absorber, particularly as a cushioning material and a shock absorber for electric appliances or electronic appliances.

The electric appliances or electronic appliances particularly include portable electric appliances or electronic appliances. Examples of the portable electric appliances or electronic appliances include a cellular phone, PHS, a smartphone, a tablet (tablet-type computer), a mobile computer (mobile PC), a personal digital assistant (PDA), an electronic notebook, a portable broadcasting receiver such as a portable television and a portable radio, a portable game machine, a portable audio player, a portable DVD player, a camera such as a digital camera, and a camcorder-type video camera. Note that examples of electric appliances or electronic appliances other than the portable electric appliances or electronic appliances include household electrical appliances and personal computers.

Therefore, when the resin foam of the present invention such as the polyester resin foam is attached to the clearance of the portable electric appliance or electronic appliance such as a cellular phone as a foam sealing material (foam sealing material of the present invention to be described below), even if it is compressed by the impact at the time of vibration and falling to be deformed or depressed to a state where it does not completely seal the clearance, it can be quickly and sufficiently recovered from the deformation and depression to sufficiently seal the clearance to effectively prevent foreign matter such as dust from entering the appliance.

Further, since the resin foam of the present invention such as the polyester resin foam is excellent in deformation recovery performance after compressive deformation, semipermanent deformation hardly remains in the resin foam even if a pressure is applied to the resin foam when a pressure-sensitive adhesive layer is provided on the resin foam with a transfer method. For example, even if a pressure of 10 to 20 N/cm² is applied to the resin foam of the present invention, the cell structure of the resin foam is not easily crushed, and the resin foam is excellent in recovery performance from deformation. Further, when a pressure-sensitive adhesive tape (tape or sheet) is laminated to the resin foam of the present invention in a sheet form, even if the resin foam is compressed by about 50% relative to the initial thickness, strain hardly remains because the resin foam is excellent in deformation recovery performance after compressive deformation.

### (Foam Sealing Material)

The foam sealing material of the present invention contains at least the resin foam of the present invention such as the polyester resin foam. The foam sealing material of the present invention may have a structure consisting only of the resin foam of the present invention, or may have a structure consisting of the resin foam and other layers (particularly, a pressure-sensitive adhesive layer (adhesive layer), a base material layer, and the like), but is not particularly limited thereto.

The shape of the foam sealing material of the present invention is preferably a sheet form (including a film form) and a tape form, but is not particularly limited thereto. The foam material may be processed so as to have desired shape, thickness, and the like. For example, it may be processed to various shapes according to the apparatus, equipment, housing, member, and the like in which it is used.

In particular, the foam sealing material of the present invention preferably has a pressure-sensitive adhesive layer. For example, the foam sealing material of the present invention preferably has a pressure-sensitive adhesive layer on the resin foam of the present invention such as the polyester resin foam. For example, when the foam sealing material of the present invention is in a sheet form, it preferably has a pressure-sensitive adhesive layer on one side or both sides thereof. When the foam sealing material of the present invention has a pressure-sensitive adhesive layer, a mount for processing, for example, can be provided on the foam sealing material of the present invention through the pressure-sensitive adhesive layer, and the foam sealing material can also be fixed or tentatively fixed to an adherend (for example, a housing, a part, or the like).

Examples of the pressure-sensitive adhesives for forming the pressure-sensitive adhesive layer include, but are not limited to, acrylic pressure-sensitive adhesives, rubber pressure-sensitive adhesives (such as natural rubber pressure-sensitive adhesives and synthetic rubber pressure-sensitive adhesives), silicone pressure-sensitive adhesives, polyester pressure-sensitive adhesives, urethane pressure-sensitive adhesives, polyamide pressure-sensitive adhesives, epoxy pressure-sensitive adhesives, vinyl alkyl ether pressure-sensitive adhesives, and fluorine pressure-sensitive adhesives. The pressure-sensitive adhesives may be used alone or in combination. Further, the pressure-sensitive adhesives may be pressure-sensitive adhesives of any form including emulsion pressure-sensitive adhesives, solvent pressure-sensitive adhesives, hot melt type adhesives, oligomer pressure-sensitive adhesives, and solid pressure-sensitive adhesives. Especially, acrylic pressure-sensitive adhesives are preferred as the pressure-sensitive adhesives from the point of view of the pollution control to adherends and the like. That is, the foam sealing material of the present invention preferably has an acrylic pressure-sensitive adhesive layer on the resin foam of the present inventions such as the polyester resin foam.

The thickness of the pressure-sensitive adhesive layer is preferably 2 to 100 μm, more preferably 10 to 100 μm, but is not particularly limited thereto. The pressure-sensitive adhesive layer is preferably as thin as possible because a thinner layer has a higher effect of preventing adhesion of soil and dust at an end. Note that the pressure-sensitive adhesive layer may have any form of a single layer and a laminate.

In the foam sealing material of the present invention, the pressure-sensitive adhesive layer may be provided through other layers (lower layers). Examples of such lower layers include other pressure-sensitive adhesive layers, an intermediate layer, an undercoat layer, and a base material layer (particularly a film layer, a nonwoven fabric layer, and the like). Further, the pressure-sensitive adhesive layer may be protected by a release film (separator) (such as a releasing paper and a release film).

Since the foam sealing material of the present invention contains the resin foam of the present invention such as the polyester resin foam, it not only has flexibility but is excellent in deformation recovery performance after compressive deformation. It is also excellent in dustproofness. It is also excellent in shading properties.

Since the foam sealing material of the present invention has the characteristics as described above, it is suitably used as a sealing material used for attaching (mounting) various members or parts to a predetermined site. In particular, it is suitably used as a sealing material used for attaching (mounting) parts constituting electric or electronic appliances to a predetermined site. The electric or electronic appliances particularly include the portable electric appliances or electronic appliances.

Examples of the various members or parts which can be attached (mounted) utilizing the foam sealing material preferably include, but are not particularly limited to, various members or parts in electric or electronic appliances. Examples of such members or parts for electric or electronic appliances include optical members or optical components such as image display members (displays) (particularly small-sized image display members) which are mounted on image display devices such as liquid crystal displays, electroluminescence displays, and plasma displays, and cameras and lenses (particularly small-sized cameras and lenses) which are mounted on mobile communication devices such as so-called “cellular phones” and “personal digital assistants”.

Examples of suitable use modes of the foam sealing material of the present invention include using it around a display such as LCD (liquid crystal display) and using by inserting it between a display such as LCD (liquid crystal display) and a housing (window part) for the purpose of dustproofing, shading, cushioning, or the like.

### EXAMPLES

Hereinafter, the present invention will be described below in more detail based on examples, but the present invention is not limited by these examples.

### Example 1

In a twin-screw kneader were kneaded, at a temperature of 220° C., 100 parts by weight of a block copolymer of polybutylene terephthalate as a hard segment and polyether as a soft segment (trade name “PELPRENE P-90BD” supplied by Toyobo Co., Ltd., melt flow rate at 230° C.: 3.0 g/10 min), 5 parts by weight of an acrylic lubricant (trade name “Metablen L-1000” supplied by Mitsubishi Rayon Co., Ltd.), 1 part by weight of hard clay (surface-treated with a silane coupling agent, trade name “ST-301” supplied by Shiraishi Calcium Kaisha, Ltd.), 5 parts by weight of carbon black (trade name “Asahi #35” supplied by Asahi Carbon Co., Ltd.), and 2 parts by weight of an epoxy modifier (epoxy-modified acrylic polymer, weight average molecular weight (Mw): 50000, epoxy equivalent: 1200 g/eq, viscosity: 2850 mPa·s). The kneaded mixture was then extruded into strands, cooled with water, and formed into pellets by cutting. Thus, a resin composition in a pellet form was obtained.

The resin composition in a pellet form was charged into a single-screw extruder (supplied by Japan Steel Works, Ltd.), and carbon dioxide gas was injected at an atmospheric temperature of 240° C. and at a pressure of 17 MPa, where the pressure became 13 MPa after injection. The resin composition in a pellet form was sufficiently saturated with the carbon dioxide gas, cooled to a temperature suitable for foaming, and extruded through a die, yielding a resin foam in a sheet form having a thickness of 2.0 mm. Note that the amount of the carbon dioxide gas mixed was 3.2% by weight relative to the total amount of the resin composition (100% by weight).

### Example 2

A resin foam was obtained in the same manner as in Example 1 except that 3.1% by weight of carbon dioxide gas was injected into the single-screw extruder.

### Example 3

In a twin-screw kneader were kneaded, at a temperature of 220° C., 100 parts by weight of a block copolymer of polybutylene terephthalate as a hard segment and polyether as a soft segment (trade name “PELPRENE P-90BD” supplied by Toyobo Co., Ltd., melt flow rate at 230° C.: 3.0 g/10 min), 5 parts by weight of an acrylic lubricant (trade name “Metablen L-1000” supplied by Mitsubishi Rayon Co., Ltd.), 3 parts by weight of hard clay (surface-treated with a silane coupling agent, trade name “ST-301” supplied by Shiraishi Calcium Kaisha, Ltd.), 5 parts by weight of carbon black (trade name “Asahi #35” supplied by Asahi Carbon Co., Ltd.), and 2 parts by weight of an epoxy modifier (epoxy-modified acrylic polymer, weight average molecular weight (Mw): 50000, epoxy equivalent: 1200 g/eq, viscosity: 2850 mPa·s). The kneaded mixture was then extruded into strands, cooled with water, and formed into pellets by cutting. Thus, a resin composition in a pellet form was obtained.

The resin composition in a pellet form was charged into a single-screw extruder (supplied by Japan Steel Works, Ltd.), and carbon dioxide gas was injected at an atmospheric temperature of 240° C. and at a pressure of 17 MPa, where the pressure became 13 MPa after injection. The resin composition in a pellet form was sufficiently saturated with the carbon dioxide gas, cooled to a temperature suitable for foaming, and extruded through a die, yielding a resin foam in a sheet form having a thickness of 1.5 mm. Note that the amount of the carbon dioxide gas mixed was 3.2% by weight relative to the total amount of the resin composition in a pellet form (100% by weight).

### Comparative Example 1

In a twin-screw kneader were kneaded, at a temperature of 200° C., 35 parts by weight of polypropylene [melt flow rate (MFR): 0.35 g/10 min], 60 parts by weight of a thermoplastic elastomer composition [a blend (olefinic thermoplastic vulcanizate, TPV) of polypropylene (PP) and an ethylene/propylene/5-ethylidene-2-norbornene terpolymer (EPT), the ratio of polypropylene to the ethylene/propylene/5-ethylidene-2-norbornene terpolymer being 25/75 based on weight, containing 15% by weight of carbon black], 5 parts by weight of a lubricant (a masterbatch in which 10 parts by weight of polyethylene was blended with 1 part by weight of stearic acid monoglyceride), 10 parts by weight of a nucleating agent (magnesium hydroxide, average particle size: 0.8 μm), and 2 parts by weight of erucamide (melting point: 80 to 85° C.). The kneaded mixture was then extruded into strands, cooled with water, and formed into pellets by cutting. Thus, a resin composition in a pellet form was obtained.

The resin composition in a pellet form was charged into a tandem single-screw extruder (supplied by Japan Steel Works, Ltd.), and 3.8% by weight of carbon dioxide gas relative to the total weight (100% by weight) was injected at an atmospheric temperature of 220° C. and at a pressure of 14 MPa, where the pressure became 18 MPa after injection. The resin composition in a pellet form was sufficiently saturated with the carbon dioxide gas, cooled to a temperature suitable for foaming, and extruded through a die, yielding a resin foam in a sheet form having a thickness of 2.0 mm.

### (Melt Tension)

Capillary Extrusion Rheometer supplied by Malvern Instruments Ltd. was used for the measurement of melt tension of a resin composition, and a tension when a resin extruded at a constant speed of 8.8 mm/min from a capillary having a diameter of 2 mm and a length of 20 mm was taken up at a take-up speed of 2 m/min was defined as melt tension.

Note that pellets before foam molding were used for measurement. In addition, the temperature at the measurement was a temperature that was higher by 10±2° C. than the melting point of the resin.

### (Degree of Strain Hardening)

Pellets before foam molding were used for the measurement of degree of strain hardening of a resin composition. The pellets were formed into a sheet form having a thickness of 1 mm using a heated hot plate press, thus obtaining a sheet. A sample (10 mm in length, 10 mm in width, 1 mm in thickness) was cut from the sheet.

Using the sample, the uniaxial elongational viscosity at a strain rate of 0.1 [1/s] was measured using a uniaxial elongational viscometer (supplied by TA Instruments Corp.). Then, the degree of strain hardening was determined by the following formula.

Degree of strain hardening=log ηmax/log η0.2 (ηmax shows the highest elongational viscosity in the measurement of the uniaxial elongational viscosity, and η0.2 shows the elongational viscosity at a strain ε of 0.2.)

Note that the temperature at the measurement was the melting point of the resin.

### (Evaluation)

Foams from Examples and Comparative Example were subjected to measurements of the density (apparent density), the average cell diameter and the maximum cell diameter in a cell structure, the repulsive force at 50% compression, the stress retention, and the thickness recovery ratio after lamination. The results are shown in Table 1.

### (Measuring Method of Apparent Density)

The density (apparent density) was calculated as follows. A resin foam in a sheet form was punched into a test piece having a size of 30 mm in width and 30 mm in length. Then, the dimension of the test piece was accurately measured with a vernier caliper to determine the volume of the test piece. Next, the weight of the test piece was measured with an electronic balance. Then, the apparent density was calculated by the following formula.

Apparent density (g/cm³)=(weight of test piece)/(volume of test piece)

### (Repulsive Force at 50% Compression (Repulsive Load at 50% Compression, 50% Compression Load, Repulsive Stress at 50% Compression))

The repulsive force at 50% compression was measured according to the method for measuring a compressive hardness prescribed in JIS K 6767.

A resin foam in a sheet form was cut into a test piece having a size of 30 mm in width and 30 mm in length. Next, the test piece was compressed in the thickness direction at a rate of compression of 10 mm/min until the test piece was compressed to a compression ratio of 50% to determine the stress (N) at this time. Then, the resulting stress (N) was converted into a value per unit area (1 cm²) to obtain a repulsive force (N/cm²) at 50% compression.

### (Measuring Method of Average Cell Diameter and Maximum Cell Diameter)

The cell diameter (μm) of each cell was determined by capturing an enlarged image of a cell portion (cell-structure portion) of a resin foam using a digital microscope (trade name “VHX-500” supplied by Keyence Corporation) and analyzing the captured image through an analysis software of this measuring instrument. Further, the number of the cells in the captured enlarged image was about 200 pieces.

Then, the average cell diameter and the maximum cell diameter were determined from the cell diameter of each cell.

### (Measuring Method of Stress Retention)

A test piece in a sheet form having a width of 30 mm, a length of 30 mm, and a thickness of 1 mm was obtained from a resin foam in a sheet form. This test piece was compressed in the thickness direction at a rate of compression of 10 mm/min using an electromagnetic force micro material tester (micro-servo) (trade name “MMT-250” supplied by Shimadzu Corporation) in an atmosphere of 23° C. until the test piece had a thickness of 20% of the initial thickness, and the compression state was held. The compressive stress after a compression holding time of 0 seconds (immediately after compression) and the compressive stress 60 seconds after holding the compression state were measured, which were defined as “compressive stress after 0 seconds” and “compressive stress after 60 seconds,” respectively. Then, the stress retention was calculated using the following formula.

Stress retention (%)=(compressive stress after 60 seconds)/(compressive stress after 0 seconds)×100

(Thickness Recovery Ratio after Lamination)

A test piece in a sheet form having a width of 200 mm, a length of 300 mm, and a thickness of 1 mm was obtained from a resin foam in a sheet form. The thickness of this test piece was defined as “initial thickness.”

Next, a double-coated pressure-sensitive adhesive tape (having a laminated structure of pressure-sensitive adhesive layer (thickness: 0.03 mm)/release liner) having a thickness of 0.03 mm was laminated to both sides of the test piece at a speed of 5 m/min using a small-sized laminator to obtain a foam sealing material (having a laminated structure of release liner/pressure-sensitive adhesive layer/resin foam/pressure-sensitive adhesive layer/release liner). When the resin foam was applied to the small-sized laminator, the resin foam had been compressed in the thickness direction so that it had a thickness of 20% of the initial thickness. The thickness of the resin foam in the resulting foam sealing material was measured, which was defined as the “thickness after lamination.”

Then, the thickness recovery ratio after lamination was calculated from the following formula.

Thickness recovery ratio (%) after lamination=(thickness after lamination)/(initial thickness)×100

### [Table 1]

TABLE 1

| | | | | | Compar- |
|---|---|---|---|---|---|
| | | Example | Example | Example | ative |
| | | 1 | 2 | 3 | Example 1 |
| Resin | Melt | 27 | 27 | 29 | — |
| composition | tension | | | | |
| | [cN] | | | | |
| | Degree of | 4.12 | 4.12 | 3.01 | — |
| | strain | | | | |
| | hardening | | | | |

| | | | | |
|---|---|---|---|---|
| Apparent density | 0.070 | 0.075 | 0.090 | 0.050 |
| [g/cm³] | | | | |
| Average cell diameter | 80 | 110 | 59 | 80 |
| [μm] | | | | |
| Maximum cell diameter | 160 | 180 | 84 | 180 |
| [μm] | | | | |
| Repulsive force at 50% | 2.2 | 2.1 | 2.5 | 1.0 |
| compression | | | | |
| [N/cm²] | | | | |
| Stress retention | 76 | 80 | 76 | 65 |
| [%] | | | | |
| Thickness recovery | 96 | 97 | 94 | 90 |
| ratio after lamination | | | | |
| [%] | | | | |

Coarse cells (voids) were not present in the resin foams of Examples, and the resin foams of Examples had uniform and fine cell structures.

### INDUSTRIAL APPLICABILITY

The resin foam and the foam sealing material of the present invention are excellent in deformation recovery performance after compressive deformation. For this reason, they can be suitably used as a sealing material, a dustproofing material, a cushioning material, a shock absorber, and the like.

1. A resin foam having a stress retention to be defined below of not less than 70%, wherein
Stress retention (%)=(compressive stress after 60 seconds)/(compressive stress after 0 seconds)×100
wherein the compressive stress after 0 seconds and the compressive stress after 60 seconds are obtained as follows: a resin foam in a sheet form having a thickness of 1.0 mm is compressed in a thickness direction in an atmosphere of 23° C. so that the resin foam has a thickness of 20% of an initial thickness, and a compression state is held; and the compressive stress immediately after compression is defined as “compressive stress after 0 seconds,” and the compressive stress 60 seconds after holding the compression state is defined as “compressive stress after 60 seconds.”

2. The resin foam according to claim 1, wherein the resin foam has an average cell diameter of 10 to 150 μm.

3. The resin foam according to claim 1, wherein the resin foam has a maximum cell diameter of less than 200 μm.

4. The resin foam according to claim 1, wherein the resin foam has an apparent density of 0.01 to 0.15 g/cm³.

5. The resin foam according to claim 1, wherein the resin foam has a repulsive force at 50% compression to be defined below of 0.1 to 4.0 N/cm²,
wherein the repulsive force at 50% compression is defined as a repulsive load when a resin foam in a sheet foam is compressed in the thickness direction in an atmosphere of 23° C. so that resin foam has a thickness of 50% of the initial thickness.

6. The resin foam according to claim 1, wherein the resin foam is formed by allowing a resin composition containing a resin to expand.

7. The resin foam according to claim 6, wherein the resin is a polyester resin.

8. The resin foam according to claim 6 or 7, wherein the resin foam is formed through the steps of impregnating the resin composition with a high-pressure gas and then subjecting the impregnated resin composition to decompression.

9. The resin foam according to claim 8, wherein the gas is an inert gas.

10. The resin foam according to claim 9, wherein the inert gas is carbon dioxide gas.

11. The resin foam according to claim 8, wherein the gas is in a supercritical state.

12. A foam sealing material comprising a resin foam according to claim 1.

13. The foam sealing material according to claim 12, wherein the foam sealing material has a pressure-sensitive adhesive layer on the resin foam.

14. The foam sealing material according to claim 13, wherein the pressure-sensitive adhesive layer is formed on the resin foam through a film layer.

15. The foam sealing material according to claim 13, wherein the pressure-sensitive adhesive layer is an acrylic pressure-sensitive adhesive layer.
